(19) United States
(12) Patent Application Publication
(10) Pub. No.: US 2004/0078302 A1
(43) Pub. Date: Apr. 22, 2004

(54) Common web facility for franchisee online sales

(76) Inventors: Andrew McDonald Cooper, Queensland (AU); Timothy John Cooper, Queensland (AU)

Correspondence Address: YOUNG & THOMPSON, 745 SOUTH 23RD STREET 2ND FLOOR, ARLINGTON, VA, 22202

(21) Appl. No.: 10/468,043

(22) PCT Filed: Feb. 15, 2002
(86) PCT No.: PCT/AU02/00165

(30) Foreign Application Priority Data
Feb. 15, 2001 (AU) PR 3133

(51) Int. Cl. G06F 17/60

(52) U.S. Cl. 705/27

(57) ABSTRACT

A web facility (10) allows a costumer to view a website (12) created by the facility (10), submit order information and make payment. The website (12) is displayed via costumer's web browser (11) utilising embedded data from both or either of a default database (13) and a linking database (14). The default database (13) is managed by the franchisor, licensor or main control body (15) of the website (12) and is used to provide generic web pages. The generic web pages may be modified by the content of the linking database (14) according to eligible franchisee costumer matching. The linking database (14) may be accessed by individual franchisees, licensees or authorised users (16) who manage or change the database's details including visual display elements, address details and so on which may be utilised in website (12).

### TECHNICAL FIELD OF THE INVENTION

This invention relates to Internet commerce and particularly to a common web facility shared by franchisees in a stable of franchisees operating under franchise agreements for facilitating sales or effective sales by or on behalf of individual franchisees.

The expression “franchise” and its associated terms as used herein refers to any contractual relationship inclusive of traditional full turnkey franchises, trade mark licenses, and also collective agreements between entities solely for the purpose of using the present invention as a means to co-ordinate online sales in a co-operative environment according to agreed criteria between independent entities.

### BACKGROUND TO THE INVENTION

Traditional franchises are usually issued for set territories. The Internet is not territory dependent and sales via the Internet are liable to result in territorial breaches of franchise agreements.

The present invention is designed but not limited to address the conflict that can occur in supplying products via the Internet between an immediate supplier to the customer and the source of the product to the supplier.

As an example, this is well shown by the conflict franchise groups encounter when franchisors formulate an Internet commerce strategy.

Franchisees often view head office forays into e-commerce as the franchiser competing directly with them via the Internet. For present purposes, this conflict between the franchisor and franchisees is referred to as “channel conflict”.

The web-site contacted first by the customer is generally owned and operated by the franchisor via a generic universal resource locator (URL) and sales through the website go to the franchisor and not the franchisees. As a result, e-commerce under these circumstances can flounder because the franchisees may not be as committed to the venture as they could be in the absence of the channel conflict.

Franchise groups have therefore been reluctant to launch Internet commerce initiatives for fear of upsetting their franchisees and affecting adversely other aspects of the business.

It is apparent that franchisees will only become committed to online commerce if they see that there is something in it for them. Most franchise agreements are based on exclusive geographical territories. Typically, the franchisees pay to the franchisor a premium for obtaining sole rights to operate within a certain geographical area under the belief that consumers will tend to gravitate to their most geographically convenient supplier outlet or store. Online commerce has the potential to undermine this arrangement, as geographic areas become redundant in the world of electronic commerce via the Internet. It is therefore in the franchisees' best interests to undermine e-commerce efforts controlled by head office or the franchisor in order to increase their share of the market.

### OUTLINE OF THE INVENTION

The present invention envisages that these deficiencies in online commerce for franchise groups can be overcome if suitable methods of tracking sales to customers from each franchise territory can be devised. The aim is to “attach” purchasers within an existing franchise territory to the relevant franchisee. Once this attachment is made, the website at the generic URL is modified by the introduction of additional content that alters the appearance of the website so that the website appears to be that of the designated supplier. All future visits to the generic URL will automatically display the altered website without going through the initial attachment process. Customer sales can be tracked back and credited to each franchisee who then can receive a previously agreed share of revenue generated.

In one aspect therefore the present invention resides in a method for facilitating sales or effective sales by or on behalf of individual franchisees in a stable of franchisees where customers access a web-site using a web browser, the method utilising a customised franchisee specific web page or customised franchisee specific web pages produced by a common web facility shared by the franchisees, the method comprising:

providing a common web facility;

providing a customer web browser enabled non-franchisee specific generic web page or generic web pages;

providing a customer differentiation process able to direct or automatically assign a customer browsing the generic page or pages, according to defined eligibility criteria, ultimately to a single eligible franchisee, or prior to the assignment of the single eligible franchisee, to a choice of eligible franchisees for the purpose of customer selection of the single eligible franchisee to which the customer is ultimately assigned, for the purpose of the said sales or for the purpose of future sales by subsequently storing the customer and single eligible franchisee assignment; and

displaying the single eligible franchisee's customised web page or pages for the purpose of transacting sales effectively via and for the benefit of the single eligible franchisee in accordance-with the single eligible franchisee's franchise agreement.

Preferably, the same URL is displayed for the generic web page(s) and for the customised web page(s). Preferably, the customised pages are generated by embedding franchisee specific data and images in the generic page(s) on the basis of data or data identifiers stored in a database.

In another aspect there is provided a common web facility shared by franchisees in a stable of franchisees operating under franchise agreements for facilitating sales or effective sales by or on behalf of individual franchisees, where customers access a web-site using a web browser, the web facility utilising a customised franchisee specific web page or customised franchisee specific web pages produced by the common web facility, the facility comprising, a default database holding data for the purpose of generating generic non-franchisee specific generic web pages, a linking database holding data for the purpose of generating customised franchisee specific web pages, a customer differentiator to assign a customer browsing the generic web pages to a single eligible franchisee according to eligibility criteria, and a web page generator to generate customised franchisee specific web pages from the database or databases in accordance with customer/franchisee assignments and online ordering facilities processing customer orders for the benefit of the single eligible franchisee in accordance with the single eligible franchisee's franchise agreement.

Preferably, the web facility includes online ordering and payment facilities.

Preferably, the online ordering facility is centrally managed and products or services are provided or directed, in the case of services, via a central despatching system.

Typically, products are despatched from a shared warehouse or from a franchisor warehouse rather than direct from the franchisees. Services would most typically be provided to the customer by the franchisee upon notification by the central dispatching system.

Preferably, the default database is managed by the franchisor.

Preferably, the franchisee's have access to there own data and assigned customer data in the linking database for the purpose of servicing assigned customers. Subject to the customer data stored franchisees may be able to utilise the central facility via a web browser or email interface to direct mail offers to assigned customers and so on.

The franchisor may have access to both databases and complete control of the facility including provision of franchisee access privileges typically by ID and password in the usual way.

Typical common programming techniques are applicable to the present invention, databases provide by Oracle or free databases such as MySql and these are accompanied by standard web based processes including online ordering and secure credit card payment. These are common in the art and the present combination may be put into practice by any competent programmer.

Typically, the whole ordering, fulfilment of the order and allocation of the franchisees share is automatic and centrally managed with payments to the franchisees being made daily or monthly subject to the franchise agreement.

In a preferred form there is provided an electronic commerce (e-commerce) system for providing goods and/or services over the Internet including the following components:

a website contactable via a generic universal resource locator (URL),

a customer information differentiator component which processes customer contact details input by the customer,

a supplier information component which matches the customer's contact details with selected supplier information and invites a customer to select a designated supplier from eligible supplier information,

an assignation component which assigns to the customer a unique customer identifier,

a linking component which links the customer identifier with the designated eligible supplier's information, the linking component further being adapted to enable alteration of the appearance of the website by additional content customised to the designated eligible supplier wherein future contact via the generic URL from a computer on which the website was initially contacted will result in display of the altered website.

Preferably, the additional content can be submitted by the designated supplier selected for display on the altered website.

Preferably, the e-commerce system further includes a compensatory component for compensating the designated supplier for its virtual presence, which is paid out of any proceeds of sales obtained by a third party supplier, typically a franchiser or his authorised supplier.

According to another preferred embodiment, the invention resides in a method for avoiding ‘channel conflict’ between a franchiser and its franchisees, in respect of requests for goods and/or services placed a customer via the Internet including the steps of:

under the control of a customer computer system, displaying to the customer information documents of one or more franchisees for selection by the customer,

responding to the customer's selection by assigning a unique customer identifier to the customer, which identifier is linked to eligible franchisee information selected,

storing the linked identifier and eligible franchisee information on a franchise service system, wherein in operation, future requests for goods and/or services placed through the customer system and received by the franchise service system causes the selected eligible franchisee information to be displayed on the customer's computer system.

Preferably, the customer computer system and the franchise service system are computer systems with interactive display means for communication via the Internet. The customer computer system typically employs an Internet browser.

### BRIEF DESCRIPTION OF THE DRAWINGS

FIG. 1 is a block diagram of a common web facility for providing an electronic commerce system according to a preferred embodiment of the invention;

FIGS. 2 and 3 are block diagrams showing typical permitted franchisee interaction with the facility that is typically via a franchisee's browser interface; and

FIG. 4 is a flow chart showing a typical process by which a customer's browser interface interacts with the facility.

### METHOD OF PERFORMANCE

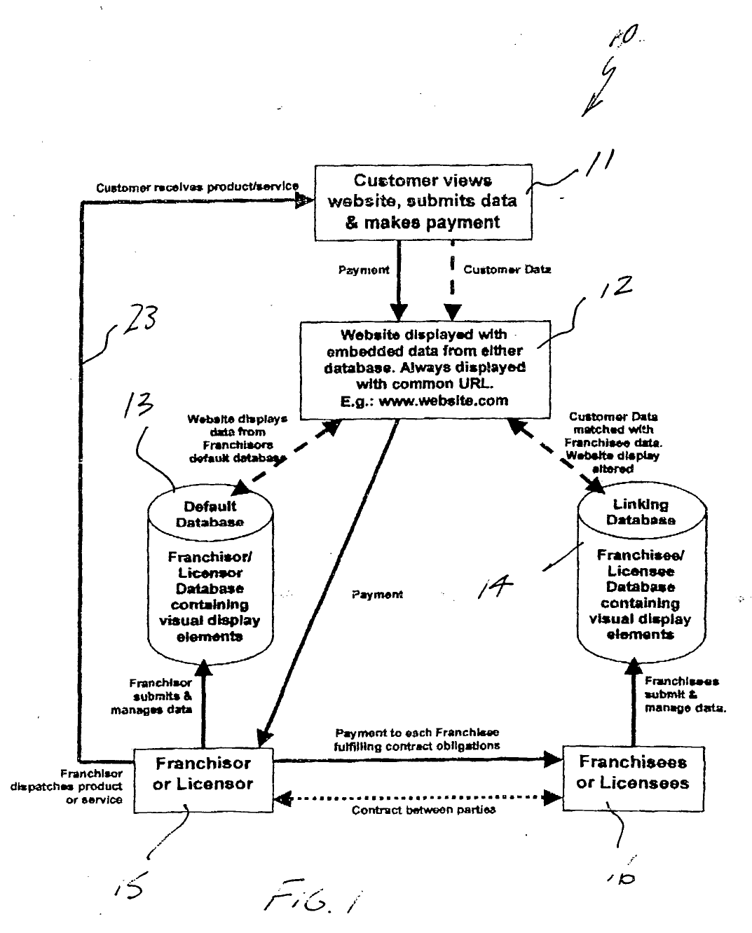

Referring to the drawings and initially to FIG. 1, there is illustrated in schematic block form a web facility 10 involving interaction between a customer's web browser shown generally at 11. A customer views a website created by the web facility, submits data including order information, and makes payment. A website is displayed via the customer's web browser utilising embedded data at 12 derived from both or either of two databases. Actual images and other content may be stored elsewhere and merely be identified by the database content.

A default database 13 and a linking database 14 are employed in this example. Other databases may be employed. The default database is managed by the franchisor or licensor or main control body of the website shown generally at 15 for the purpose of providing generic web pages that may be modified by the linking database content according to eligible franchisee customer matching.

The linking database may be accessed by individual franchisees, licensees or other users authorised to do so, and this is shown generally at 16. In each case, the databases may be managed to change details including visual display elements, address details and so on, as may be displayed from time to time on the website displayed at 12.

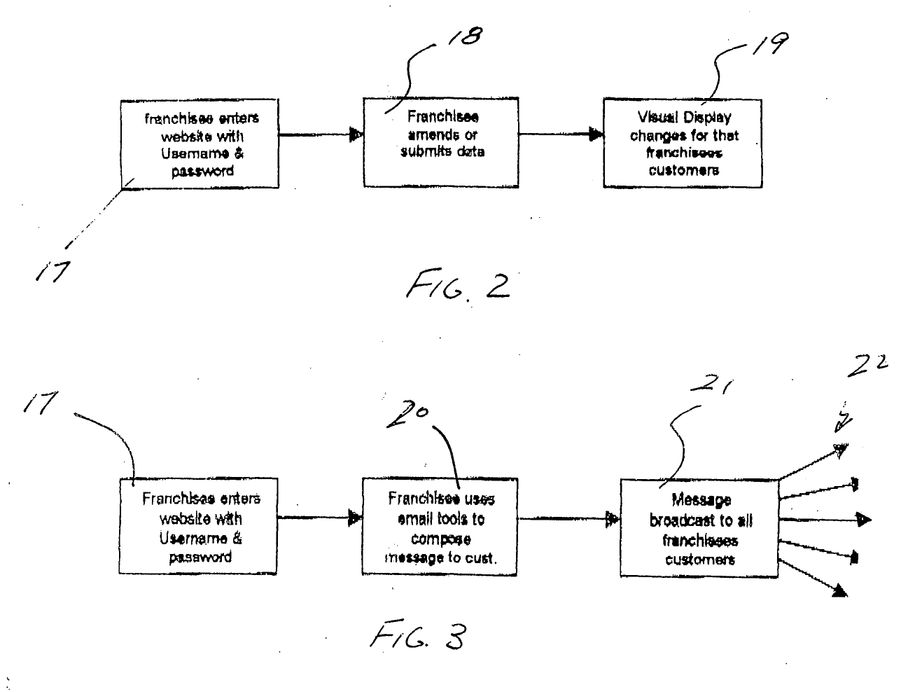

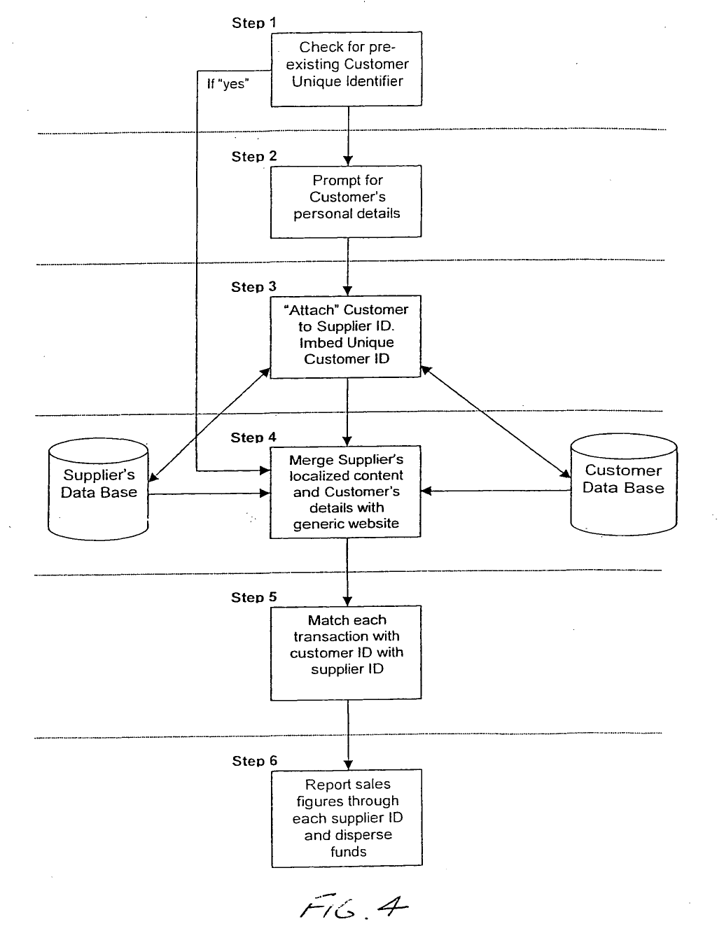

FIGS. 2 and 3 illustrate the two most typical processes by which franchisees access the facility at item 16 of FIG. 1. FIG. 2 illustrates the franchisee accessing the web facility via the franchisee's web browser at 17, utilising a user name and password allocated by the franchisor or main controller of the facility. The franchisee can amend and submit data at 18, which in turn is stored in database 14 for the purpose of changing content for the customised web pages to the customer's browser, as shown generally at 19. Via the same entry passageway also numbered 17 in FIG. 3, the franchisee can enter the website and can use email tools provided in the facility at 20 to broadcast emails shown generally at 21 to customers as designated by the arrows at 22. Customers will be allocated to the linking database termed “the customer database” in FIG. 4 according to the typical sequence depicted in relation to FIG. 4 to be described below.

It will be noted in reference to FIG. 1, that the entire system from customer interaction, the display of the generic website and franchisee specific website from the linking database can be displayed with a single URL due to the use of embedded data from either database as a composite. The whole system can be self-contained save for the delivery of products/services along line 23.

### EXAMPLE 1

Referring to FIG. 4 there is shown a flow diagram of the invention according to Example 1 being a preferred form whereby a customer only visits the generic URL once for the purpose of assignment whereby the users computer stores an identifier so that the user is routed to the selected eligible supplier/franchisee upon each subsequent visit.

Step 1 refers to the checking of each user of the general URL (website) for a previously assigned unique identifier for matching purposes. If the system identifies the user as previously logged into the system then it will immediately and automatically jump to Step 4. If the user has not previously logged information then they will be directed to Step 2 and prompted for relevant data.

Step 2 refers to the collection of customers' personal contact details. When a customer enters the generic website of the franchisor and prior to any initial transaction, each customer is required to enter their personal details including name, address and phone number which is processed by a customer information component of the system to ensure delivery of the relevant goods or services and to enable assignment to a franchisee.

Step 3 refers to the matching of the customer's store preferences to a supplier's localised details by a supplier information component of the system wherein once the customer's details have been entered, the system accesses a separate database of franchisee details and runs a matching program which seeks to identify an appropriate franchisee or franchisees for the customers given territorial location, age or other demographic that may define the franchise contractural criteria. The system is able to do this in a variety of ways but preferably involves the presentation to the customer on a visual display unit of selected outlets or stores closest to the customer's location. Preferably this is based on the postcode of the customer's address. The customer is then invited to select a particular outlet or store and effectively becomes attached or linked by a linking component to the designated franchisee in control of the selected outlet or store. The system then embeds a unique identifier, preferably a numeric or alphanumeric sequence to the customer's browser, which resides permanently there unless deleted by the customer. This unique identifier identifies the customer's computer for the current and/or future visits to the generic website and the customer's preferred supplier/store unless deleted and forms the basis of tracking orders and revenue for future disbursements to individual franchisees. All future transactions are logged with customer identifier and supplier identifier for later retrieval.

Step 4 refers to the merging of the franchisee's details with the generic website to display a website that appears to be the franchisee's. Each individual customer that has been linked to a franchisee of the selected outlet or store will view a website that appears to be the selected franchisee's website as distinct to the generic website that the customer originally viewed (even though the URL has not changed). This process is achieved by embedding the selected franchisee's details i.e. the designated franchisee's information into the underlying generic website, which is normally controlled by the franchisor. The software draws out of the selected supplier information or linking database the franchisee's details which is displayed with the generic website viewed by a particular customer. Other customers can simultaneously be viewing the same underlying generic website with access to different designated supplier information or franchisee details wherein different data is drawn from the selected supplier information or franchisee linking database.

Step 5 refers to the automatic recording of every transaction conducted through the system and assigning each one to the appropriate supplier. Each supplier has been assigned credit for sales to customers that belong to their franchise area.

Step 6 refers to the reporting of results and rewarding of franchisees by means of using the unique numeric or alphanumeric identifier. Sales made to customers which are attached to each of the relevant selected and designated franchisees can be calculated and appropriate rewards made to the franchisees.

Once the unique customer identifier has been linked to the designated supplier or franchisee's information, whenever the customer returns to the generic website the particular designated franchisee's custom website is displayed. This eliminates the necessity for the customer to continually submit any personal information to establish the customer/franchisee relationship.

The embedded unique customer identifier is recognised by the system which has already attached the customer's browser to the website of the designated franchisee. Preferably the customer also has the facility to de-link themselves from the particular designated franchisee and to be linked with another franchisee should the customer change its geographical location or address.

### EXAMPLE 2

In another preferred embodiment the invnetion may be put into practice as follows.

1. Customer & Supplier ID's

1.1 Every visitor to the website automatically and immediately has a Unique Identifier or Cookie embedded. The actual user still remains anonymous.

1.2 The website Universal Resource Locator (URL) maintains a generic form. For example www.website.com.

1,3 Website Visual Display remains generic and only displays information from the generic database

1.4 The Unique ID then effectively identifies an individual

1.5 Customer submits delivery information for delivery or in response to a request. Information is submitted in database forms with separate fields for each item. EG: name, address, postcode, email address etc

1.6 Program matches required field against appropriate field in franchisee's linking database. This combination effectively matches website visitors with appropriate franchisees. For example, the visitor's postcode is matched against the postcodes of each franchisees territory if territory is the basis of the franchisee's eligibility.

1.7 The embedded Cookie (Unique Identifier) survives logging off by the visitor and can be used on subsequent visits to immediately identify the visitor and his matched franchisee.

2. Supplier or Franchisee Database

2.1 An electronic database is created to store franchisee information. This information can be very comprehensive or superficial. Examples of information include Contact Details, Location Maps, Store Photo, Written Content to appear on the website, Specials or Promotions that each franchisee wishes to publicise and virtually anything else they would like to appear on the customised franchisee specific website. Crucially important is the data pertaining to the franchisee's territory that is usually based on postcodes. That is, each franchisee has certain rights over people potential customers in certain postcodes.

2.2 This database can be managed either centrally or by allowing franchisees to access the database with security passwords to submit or change data.

3. Customer Database

3.1 Electronic database created with fields for customers or visitors to complete. Usually this is conducted through an online form with specific fields displayed for completion.

3.2 This database is stored as a customer file and attached to the embedded Cookie or Unique Identifier. Through the Unique Identifier the system now has information on the customer and the franchisee that is attached to that customer.

4. Merging Process

4.1 Visitors are immediately identified through previously embedded Unique Identifier.

4.2 The software changes the display of the website from information contained in the generic database to that also contained in the franchisee's database. For example, the website home page may now contain the customer's local franchisee's contact details, location map etc

4.3 The websites home page changes appearance for each individual viewing the website but for all individuals the URL keeps the same generic form www.website.com. The website is dynamic and draws from different databases but the URL remains static.

4.4 The type or extent of change of the website depends upon the depth of information in the franchisee's database and the marketing objectives of the franchisees.

5. Franchisee's Database

5.1 Franchisees can be issued with User Names and Security Passwords for access to the franchisee database.

5.2 Accessing the database, the franchisees can manipulate, submit or change the data in that database.

5.3 Changing the data has a direct affect on the visual display.

5.4 The franchisees therefore can manipulate the display of their content displayed to customers within their territory.

6. Direct Marketing

6.1 Each customer database file is attached to a franchisee.

6.2 Each franchise can access their customer lists through entering the database using the security passwords.

6.3 Email marketing tools will allow the franchisee to send email directly to ONLY those customers that reside within their territory.

6.4 A download of all customer details can also be performed for adding to the franchisees traditional marketing programs.

Whilst the above has been given by way of illustrative example of the present invention many variations and modifications thereto will be apparent to those skilled in the art without departing from the broad ambit and scope of the invention as set out in the appended claims.

1. A method for facilitating sales or effective sales by or on behalf of individual franchisees in a stable of franchisees where customers access a web-site using a web browser, the method utilising a customised franchisee specific web page or customised franchisee specific web pages produced by a common web facility shared by the franchisees, the method comprising:
providing a common web facility;
providing a customer web browser enabled non-franchisee specific generic web page or generic web pages;
providing a customer differentiation process able to direct or automatically assign a customer browsing the generic page or pages, according to defined eligibility criteria, ultimately to a single eligible franchisee, or prior to the assignment of the single eligible franchisee, to a choice of eligible franchisees for the purpose of customer selection of the single eligible franchisee to which the customer is ultimately assigned, for the purpose of the said sales or for the purpose of future sales by subsequently storing the customer and single eligible franchisee assignment; and
displaying the single eligible franchisee's customised web page or pages for the purpose of transacting sales effectively via and for the benefit of the single eligible franchisee in accordance with the single eligible franchisee's franchise agreement.

2. The method according to claim 1 wherein, the same URL is displayed for the generic web pages and for the customised web pages.

3. The method according to claim 1 wherein the customised pages are generated by embedding franchisee specific data and images on the basis of data identifiers stored in a database.

4. The method according to claim 1 wherein, the same URL is displayed for the generic web pages and for the customised web pages, the customrised pages being generated by embedding franchisee specific data and images on the basis of data identifiers stored in a database.

5. The method according to claim 1 wherein content of the customised web pages may be changed by a franchisee authorised to do so.

6. The method according to claim 1 wherein the customised pages are generated by embedding franchisee specific data and images on the basis of data identifiers stored in a database and content of the customised web pages may be changed by a franchisee authorised to do so.

7. A common web facility shared by franchisees in a stable of franchisees operating under franchise agreements for facilitating sales or effective sales by or on behalf of individual franchisees, where customers access a website using a web browser, the web facility utilising a customised franchisee specific web page or customised franchisee specific web pages produced by the common web facility, the facility comprising, a default database holding data for the purpose of generating generic non-franchisee specific generic web pages, a linking database holding data for the purpose of generating customised franchisee specific web pages, a customer differentiator to assign a customer browsing the generic web pages to a single eligible franchisee according to eligibility criteria, and a web page generator to generate customised franchisee specific web pages from the database or databases in accordance with customer/franchisee assignments and online ordering facilities processing customer orders for the benefit of the single eligible franchisee in accordance with the single eligible franchisee's franchise agreement.

8. A web facility according to claim 7 wherein the web facility includes online ordering and payment facilities, the online ordering facility being centrally managed and products or services are provided or directed, in the case of services, via a central despatching system.

9. A web facility according to claim 7 wherein the web facility includes online ordering and payment facilities, the default database being managed by the franchisor and the linking database being managed by the franchisees according to access permissions wherein individual franchisee's have access to there own data and assigned customer data in the linking database for the purpose of changing the customised display servicing assigned customers.

10. A web facility according to claim 7 wherein the web facility includes online ordering and payment facilities, the default database being managed by the franchisor and the linking database being managed by the franchisees according to access permissions wherein individual franchisee's have access to there own data and assigned customer data in the linking database for the purpose of changing the customised display servicing assigned customers and to utilise the central facility via an email interface web browser to direct mail offers to assigned customers.

11. A web facility according to claim 7 wherein the whole ordering, fulfilment of the order and allocation of the franchisees share of any transaction is automatic and central an centrally managed with periodic payments to the franchisee being made subject to a franchise agreement.

12. An electronic commerce (e-commerce) system for providing goods and/or services over the Internet including the following components:
a website contactable via a generic universal locator (URL),
a customer information differentiator component which processes customer contact details input by the customer,
a supplier information component which matches the customer's contact details with selected supplier information and invites a customer to select a designated supplier from eligible supplier information,
an assignation component which assigns to the customer a unique customer identifier,
a linking component which links the customer identifier with the designated eligible supplier's information, the linking component further being adapted to enable alteration of the appearance of the website by additional content customised to the designated eligible supplier wherein future contact via the generic URL from a computer on which the website was initially contacted will result in display of the altered website.

13. An electronic commerce (e-commerce) system according to claim 12 wherein the additional content is submitted by the designated supplier selected for display on the altered website.

14. An electronic commerce (e-commerce) system according to claim 12 wherein the e-commerce system further includes a compensatory component for compensating the designated supplier for its virtual presence, which is paid out of any proceeds of sales obtained by a third party supplier, franchisor or the frachisor's authorised supplier.

15. A method for avoiding ‘channel conflict’ between a franchisor and its franchisees, in respect of requests for goods and/or services placed a customer via the Internet including the steps of:
under the control of a customer computer system, displaying to the customer information documents of one or more franchisees for selection by the customer, responding to the customer's selection by assigning a unique customer identifier to the customer, which identifier is linked to eligible franchisee information selected,
storing the linked identifier and eligible franchisee information on a franchise service system, wherein in operation, future requests for goods and/or services placed through the customer system and received by the franchise service system causes the selected eligible franchisee information to be displayed on the customer's computer system.

16. A method according to claim 15 wherein the customer computer system and the franchise service system are computer systems with interactive display means for communication via the Internet.
